(19) United States
(12) Patent Application Publication
(10) Pub. No.: US 2026/0290692 A1
(43) Pub. Date: Sep. 24, 2026

(54) MULTILAYER CERAMIC CAPACITOR

(71) Applicant: TAIYO YUDEN CO., LTD., Tokyo (JP)

(72) Inventor: Tsuyoshi SOGABE, Tokyo (JP)

(21) Appl. No.: 19/543,143

(22) Filed: Feb. 18, 2026

(30) Foreign Application Priority Data
Mar. 24, 2025 (JP) 2025-048800

(51) Int. Cl. H01G 4/12; H01G 4/008; H01G 4/30

(52) U.S. Cl. CPC H01G 4/1227; H01G 4/008; H01G 4/30

(57) ABSTRACT

A multilayer ceramic capacitor is provided and includes a body including a plurality of dielectric layers and a plurality of internal electrode layers that are alternately laminated in a first-axis direction. The internal electrode layers include Ni. The dielectric layers include a perovskite compound represented by general formula ABO₃. The internal electrode layers are free from a co-existent material. An average thickness of the internal electrode layers is less than 500 nm. The dielectric layers include secondary phases covering interfaces between the dielectric layers and the internal electrode layers. A coverage of the interfaces by the secondary phases is 30% or more. Of the secondary phases, a percentage of the secondary phases including Ni is 80% or more.

### CROSS-REFERENCE TO RELATED APPLICATIONS

This patent application is based on and claims priority to Japanese Patent Application No. 2025-048800 filed on Mar. 24, 2025, the entire contents of which are incorporated herein by reference.

### TECHNICAL FIELD

The present disclosure relates to a multilayer ceramic capacitor.

### BACKGROUND

Multilayer ceramic capacitors (MLCCs) have a structure in which dielectric layers and internal electrode layers are alternately laminated. Also, multilayer ceramic capacitors are used in various electronic devices, such as mobile phones, personal computers, and the like.

In recent years, in response to progressing multifunctionality, increasing performance, and the like of electronic devices to which such multilayer ceramic capacitors are mounted, the multilayer ceramic capacitors are required, for example, to be thinner and to have higher capacitance. The multilayer ceramic capacitors satisfying such requirements can cause discontinuation of the internal electrode layers. This is because of progressing rounding of the internal electrode layers due to growth of metal particles caused by the difference in thermal contraction between the dielectric layers and the internal electrode layers during firing.

In view of this, for example, Patent Document 1 discloses a multilayer ceramic electronic component in which ceramic particles as a co-existent material are included in the internal electrode layers at a specific rate to reduce the difference in thermal contraction from the dielectric layers, thereby preventing discontinuation of the internal electrode layers.

### RELATED ART DOCUMENT

### Patent Document

Patent Document 1: Japanese Laid-Open Patent Application Publication No. 2003-077761

### SUMMARY

According to one aspect of the present disclosure, a multilayer ceramic capacitor includes: a body including a plurality of dielectric layers and a plurality of internal electrode layers that are alternately laminated in a first-axis direction. The internal electrode layers include Ni. The dielectric layers include a perovskite compound represented by general formula ABO₃. The internal electrode layers are free from a co-existent material. An average thickness of the internal electrode layers is less than 500 nm. The dielectric layers include secondary phases covering interfaces between the dielectric layers and the internal electrode layers. A coverage of the interfaces by the secondary phases is 30% or more. Of the secondary phases, a percentage of the secondary phases including Ni is 80% or more.

### BRIEF DESCRIPTION OF THE DRAWINGS

FIG. 1 is a perspective diagram of a multilayer ceramic capacitor according to an embodiment of the present disclosure.

FIG. 2 is a cross-sectional diagram taken along the line A-A of FIG. 1.

FIG. 3 is a cross-sectional diagram taken along the line B-B of FIG. 1.

FIG. 4 is an enlarged diagram of a region C of FIG. 2.

FIG. 5 is a diagram for describing an evaluation method of a continuation percentage of an internal electrode layer.

FIG. 6 is a flowchart illustrating a production method of the multilayer ceramic capacitor according to the embodiment.

### DETAILED DESCRIPTION

In the multilayer ceramic electronic component including the co-existent material in the internal electrode layers like in the invention described in Patent Document 1, there has been a concern that the internal electrode layers are readily discontinued due to thinning of the internal electrode layers and remaining of the co-existent material in the internal electrode layers after firing, resulting in a decrease in the continuation percentage of the internal electrode layers.

According to one aspect of the present disclosure, it is possible to provide a multilayer ceramic capacitor having an excellent continuation percentage of an internal electrode layer.

Hereinafter, embodiments of the present disclosure (hereinafter may be referred to as the present embodiment) will be described in detail, but the present disclosure is not limited to the embodiments. In the present specification and drawings, components having substantially the same functional configuration are denoted by the same reference signs, and thus duplicate description thereof may be omitted. In some of the drawings, an X axis, a Y axis, and a Z axis, which are orthogonal to each other, are shown appropriately. The X axis, Y axis, and Z axis define a fixed coordinate system that is fixed with respect to a multilayer ceramic capacitor. When the outer shape of the multilayer ceramic capacitor, which is an example of a multilayer ceramic electronic component, is a substantially rectangular parallelepiped shape, the X axis, Y axis, and Z axis can correspond to the length, width, and height of the multilayer ceramic capacitor.

### [Basic Structure of Multilayer Ceramic Capacitor]

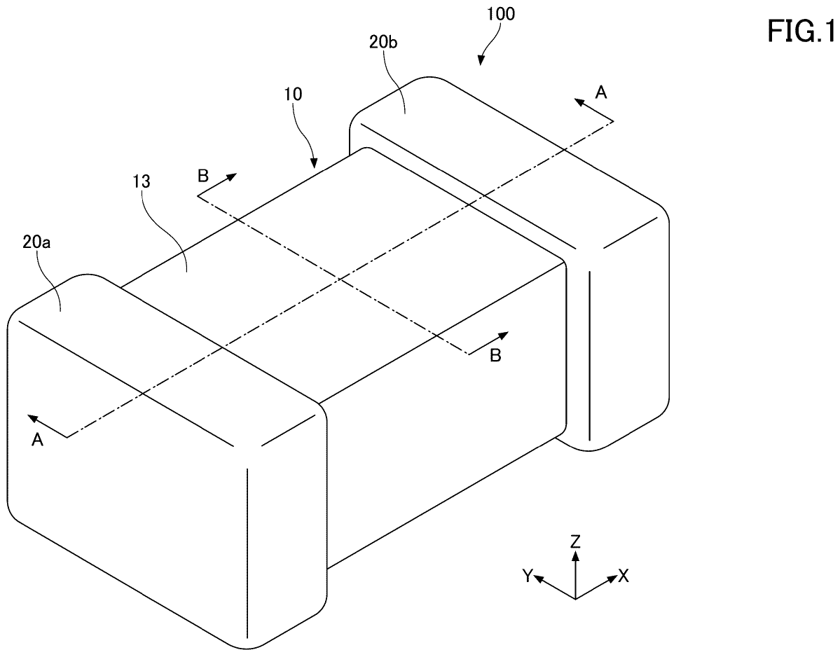

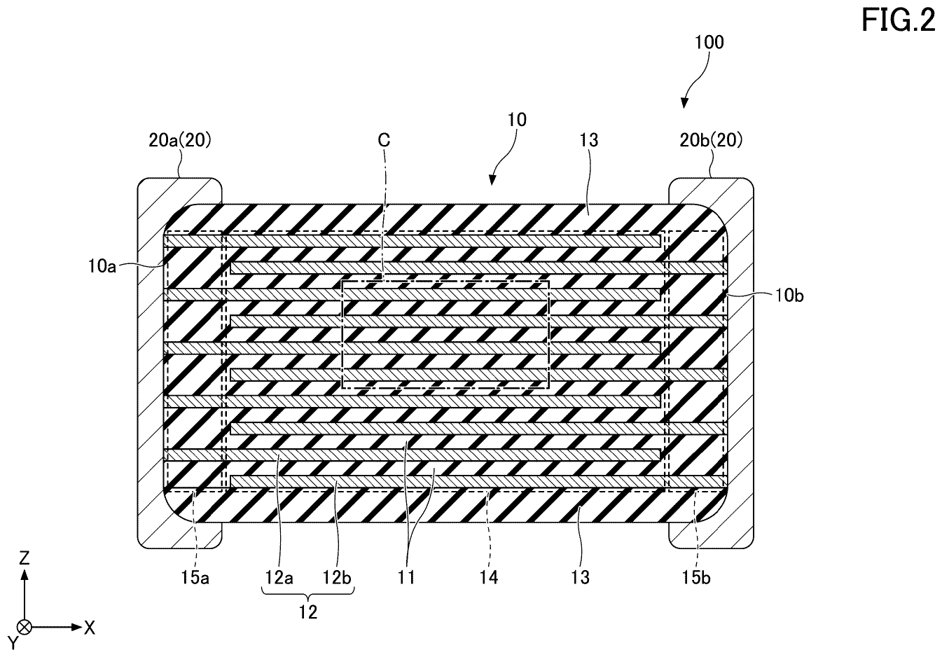

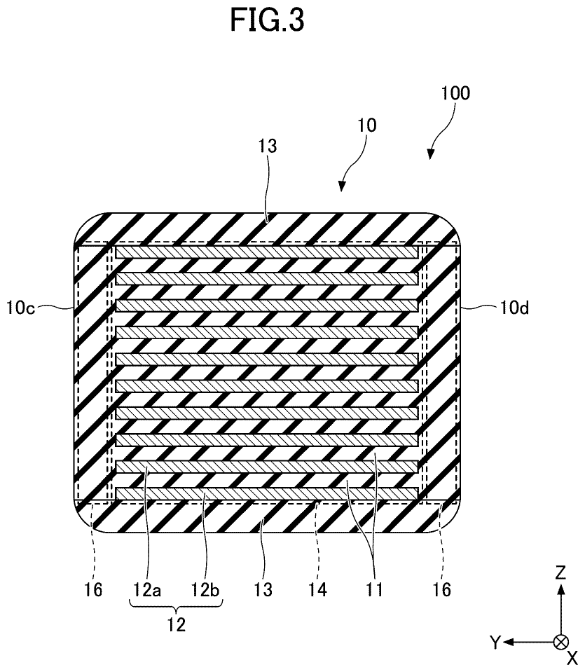

FIG. 1 is a perspective diagram of a multilayer ceramic capacitor 100 according to an embodiment of the present disclosure. FIG. 2 is a cross-sectional diagram taken along the line A-A of FIG. 1. FIG. 3 is a cross-sectional diagram taken along the line B-B of FIG. 1.

As illustrated in FIGS. 1 to 3, the multilayer ceramic capacitor 100 includes a body 10 having a substantially rectangular parallelepiped shape. Two opposing planes of the body 10 are referred to as an upper plane and a lower plane, and four planes connecting the upper plane and the lower plane are referred to as side planes. Typically, when a multilayer ceramic capacitor is mounted on a circuit board, a plane on the substrate side is referred to as a lower plane, which is, however, non-limiting.

In the examples illustrated in FIGS. 1 to 3, a first external electrode 20a and a second external electrode 20b are respectively provided on a first side plane 10a and a second side plane 10b (see FIG. 2), which are two opposing side planes of the body 10.

The first external electrode 20a extends from the first side plane 10a to four planes next to the first side plane 10a. The second external electrode 20b extends from the second side plane 10b to four planes next to the second side plane 10b. Also, the first external electrode 20a and the second external electrode 20b are spaced from each other. The planes on which the external electrodes are provided are not limited to the two opposing side planes of the body 10 as long as the external electrodes are provided on the surface of the body 10.

The body 10 has a configuration in which dielectric layers 11, including a ceramic material functioning as a dielectric material, and internal electrode layers 12 are alternately laminated in a first-axis direction.

The internal electrode layers 12 include a plurality of first internal electrode layers 12a and a plurality of second internal electrode layers 12b. The first internal electrode layers 12a and the second internal electrode layers 12b are alternately laminated. Ends of the first internal electrode layers 12a are routed out to a surface of the body 10 on which the first external electrode 20a is provided, i.e., the first side plane 10a in FIGS. 1 to 3. Ends of the second internal electrode layers 12b are routed out to a surface of the body 10 on which the second external electrode 20b is provided, i.e., the second side plane 10b in FIGS. 1 to 3. With this configuration, the first internal electrode layers 12a and the second internal electrode layers 12b are alternately electrically connected to the first external electrode 20a and the second external electrode 20b. Therefore, the multilayer ceramic capacitor 100 has a configuration in which a plurality of capacitor units are laminated. The number of the dielectric layers 11 and the number of the internal electrode layers 12 in FIGS. 1 to 3 are merely examples for ease of understanding of the description. The multilayer ceramic capacitor of the present embodiment may include a larger number of laminated layers.

A lamination direction in which the dielectric layers 11 and the internal electrode layers 12 are laminated is the first-axis direction. As illustrated in FIGS. 1 to 3, when the first-axis direction, i.e., the lamination direction, is a direction along the Z axis in the fixed coordinate system (Z-axis direction), the Z axis is the lamination direction in which the dielectric layers 11 and the internal electrode layers 12 are laminated, and is a direction in which the internal electrode layers face each other.

An axis perpendicular to the first axis, i.e., the lamination direction, is a second axis. As illustrated in FIGS. 1 to 3, when the second axis perpendicular to the first axis, i.e., the lamination direction, is a direction along the X axis (X-axis direction), the X axis is a direction in which the internal electrode layers 12 are routed out and in which the first side plane 10a and the second side plane 10b of the body 10 face each other or the first external electrode 20a and the second external electrode 20b face each other. In the examples illustrated in FIGS. 1 to 3, the electrode routed-out direction (X-axis direction) is a direction along a longitudinal direction of the body 10.

An axis perpendicular to the first axis, i.e., the lamination direction, and perpendicular to the second axis is a third axis. As illustrated in FIGS. 1 to 3, when the third axis perpendicular to the first axis, i.e., the lamination direction, and perpendicular to the second axis is a direction along the Y axis (Y-axis direction), the Y axis is an axis along a direction in which a third side plane 10c and a fourth side plane 10d of the four side planes of the body 10 face each other. In the examples illustrated in FIGS. 1 to 3, the direction along the Y axis is a direction along a width direction of the body 10.

The X-axis direction, Y-axis direction, and Z-axis direction are orthogonal to each other. The lamination direction is not limited to a Z direction and may be any other direction. Therefore, for example, the first axis, i.e., the lamination direction, may be the X axis along an X direction or may be the Y axis along a Y direction.

In the present specification, for the description of general embodiments, a diagram illustrating a specific embodiment of the general embodiments may be used. However, the content described based on the coordinate system used in the specific embodiment is applied to general coordinate systems in the general embodiments in which the lamination direction is the first axis. For example, the X axis, Y axis, and Z axis used in FIGS. 1 to 3, in which the lamination direction coincides with the Z direction as the specific embodiment, can be applied to the general embodiments by reading the X axis, Y axis, and Z axis as the second axis, the third axis, and the first axis, respectively.

A region in which the first internal electrode layers 12a connected to the first external electrode 20a and the second internal electrode layers 12b connected to the second external electrode 20b face each other is referred to as a capacitor portion 14. The capacitor portion 14 is a region of the multilayer ceramic capacitor 100 in which electrical capacitance is generated. In other words, the capacitor portion 14 is a region in which adjacent internal electrode layers connected to the different external electrodes face each other via the dielectric layer.

In the capacitor portion 14 in which the dielectric layers 11 and the internal electrode layers 12 are laminated, the outermost portions in the lamination direction (Z-axis direction) are formed by the internal electrode layers 12. Also, cover layers 13 may be disposed on the outer planes of the capacitor portion 14 in the lamination direction, i.e., on the outer planes of the outermost internal electrode layers 12 in the lamination direction.

The cover layers 13 are layers including a ceramic material functioning as a dielectric material. The cover layers 13 may have a composition the same as or different from the composition of the dielectric layers 11.

As long as the first internal electrode layers 12a and the second internal electrode layers 12b are exposed to different regions of the surface of the body 10 and are electrically connected to different external electrodes, the configuration of the body 10 is not limited to the configuration illustrated in FIGS. 1 to 3. The different regions of the surface of the body 10 may be respective surface regions of opposing planes of the surface of the body 10, respective surface regions of planes next to each other, or different surface regions of the same plane. As long as the different external electrodes are spaced from each other, the external electrodes may extend, to other planes, from the planes of surface regions of the laminate to which the first internal electrode layers 12a and the second internal electrode layers 12b are exposed. Although not illustrated in FIGS. 1 to 3, the dielectric layers 11 include a plurality of secondary phases 40 described in detail below. The secondary phases 40 cover the interface between one dielectric layer 11 of the dielectric layers 11 and one internal electrode layer 12 of the internal electrode layers 12, the one dielectric layer 11 and the one internal electrode layer 12 being next to each other.

A region in which the first internal electrode layers 12a connected to the first external electrode 20a face each other in the lamination direction without the second internal electrode layers 12b connected to the second external electrode 20b being interposed therebetween is referred to as a first end margin 15a. Also, a region in which the second internal electrode layers 12b connected to the second external electrode 20b face each other in the lamination direction without the first internal electrode layers 12a connected to the first external electrode 20a being interposed therebetween is referred to as a second end margin 15b. Each end margin is a region in which the internal electrode layers connected to the same external electrode face each other in the lamination direction without the internal electrode layers connected to the different external electrode being interposed therebetween. The first end margin 15a and the second end margin 15b are regions in which no electrical capacitance is generated.

As illustrated in FIG. 3, a region provided next to the outside of the capacitor portion 14 in the Y-axis direction is referred to as a side margin 16. The side margin is an outside region next to the capacitor portion 14 on the side where the internal electrode layers 12 are not routed out. The side margin 16 is a region in which no electrical capacitance is generated.

No particular limitation is imposed on the size of the multilayer ceramic capacitor 100, and the size of the multilayer ceramic capacitor 100 may be appropriately selected in accordance with the intended purpose. For example, the size of the multilayer ceramic capacitor 100 may be: 0.25 mm (millimeters) in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the above-listed sizes of the multilayer ceramic capacitor 100 are merely examples, and the size of the multilayer ceramic capacitor is not limited to the above sizes.

The size of the multilayer ceramic capacitor 100 may be, for example, as follows: length>width≥height; width>length≥height; height>length≥width; or height>width≥length. The ceramic capacitor 100 illustrated in FIGS. 1 to 3 has a length in the X-axis direction (electrode routed-out direction), a width in the Y-axis direction, and a height in the Z-axis direction (lamination direction).

### (Dielectric Layer)

The dielectric layers 11 include a compound having a perovskite structure represented by the general formula ABO₃, and may further include other components, if necessary.

### <Perovskite Compound>

The dielectric layer 11 includes a compound having a perovskite structure represented by the general formula ABO₃ (which may be referred to as a perovskite compound) as a main component. In the present specification, the description of including a predetermined component as a main component means that the predetermined component is included in the largest amount in terms of a ratio by mol among the included components.

No particular limitation is imposed on the amount of the perovskite compound included in the dielectric layers 11. The amount of the perovskite compound included in the dielectric layers 11 may be appropriately selected in accordance with the intended purpose, and may be, for example, 50 atomic % or more, 60 atomic % or more, 80 atomic % or more, 90 atomic % or more, or 95 atomic % or more. The perovskite structure may be deficient in oxygen compared to the stoichiometric composition. That is, the perovskite compound may be represented as ABO_{3-α} deviating from the stoichiometric composition (0<α≤1: a represents an amount deviating from the stoichiometric composition).

As the perovskite compound, it is possible to use one or more of, for example, barium titanate (BaTiO₃) calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming the perovskite structure.

Specific examples of Ba_{1-x-y}CaₓSr_{y}Ti_{1-z}Zr_{z}O₃ include strontium barium titanate, calcium barium titanate, barium zirconate, barium zirconate titanate, calcium zirconate titanate, calcium barium zirconate titanate, and the like.

Of these perovskite compounds, barium titanate (BaTiO₃) is preferable from the viewpoint of excellent dielectric characteristics, such as a high dielectric constant, small dielectric loss, and the like. When the dielectric layers 11 include barium titanate as the perovskite compound, the electrostatic capacitance of the multilayer ceramic capacitor 100 can be increased.

Barium titanate can be typically obtained by reacting a titanium raw material, such as titanium dioxide or the like, with a barium raw material, such as barium carbonate or the like.

No particular limitation is imposed on the synthesis method of the ceramic powder including the perovskite compound serving as a main component of the dielectric layer 11, and the synthesis method may be appropriately selected in accordance with the intended purpose. Examples of the synthesis method include a solid-phase method, a sol-gel method, a hydrothermal method, and the like.

The dielectric layers 11 may include an additive other than the above-described ceramic material. Examples of the additive include: simple substances or compounds including one or more elements selected from zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); simple substances or compounds including one or more elements selected from cobalt (Co), nickel (Ni), lithium (Li), boron (B), sodium (Na), potassium (K), and silicon (Si); glass including an oxide including one or more elements selected from cobalt, nickel, lithium, boron, sodium, potassium, and silicon; and the like.

The dielectric layers 11 may include copper (Cu). When the dielectric layers 11 include copper, the concentration of copper in the dielectric layers 11 is preferably 0.1 atomic % or less from the viewpoint of ensuring insulation of the dielectric material.

No particular limitation is imposed on the thickness (micrometer) of the dielectric layers 11, and the thickness of the dielectric layers 11 may be appropriately selected in accordance with the intended purpose. The thickness of the dielectric layers 11 is 0.1 micrometers or greater and 0.5 micrometers or less. According to the multilayer ceramic capacitor of the present embodiment, even if the thickness of the dielectric layers 11 is 0.5 micrometers or less, discontinuation of the internal electrode layers 12 is suppressed to maintain the continuation percentage of the internal electrode layers 12.

No particular limitation is imposed on the measurement method of the thickness (micrometer) of the dielectric layers 11, and the measurement method may be appropriately selected in accordance with the intended purpose. For example, the thickness (micrometer) of the dielectric layers 11 can be evaluated through observation of a cross section of the multilayer ceramic capacitor 100. More specifically, the multilayer ceramic capacitor is polished along the X-axis direction or the Y-axis direction to expose a YZ or XZ plane of the capacitor portion 14. Here, the plane to be exposed through polishing is preferably a plane near the center of the capacitor portion 14 in the X-axis direction or the Y-axis direction. The exposed surface is imaged by a laser microscope or the like, and about 5 to about 10 layers are selected from each of the center portion, the upper end portion, and the lower end portion in the Z-axis direction, i.e., the lamination direction of the dielectric layers 11, such that a total of 15 to 20 dielectric layers 11 are selected. The thickness (length in the Z-axis direction) of each of the selected dielectric layers 11 is measured at positions corresponding to ¼, ½, and ¾ of the width of each dielectric layer 11, and the average of the measurement values can be defined as the thickness (micrometer) of each dielectric layer 11. The thicknesses of all the selected dielectric layers 11 each measured in this manner are averaged, and the obtained average of the thicknesses of all the selected dielectric layers 11 can be used as the thickness (average thickness) (micrometer) of the dielectric layers 11. The imaging by the laser microscope or the like may be performed at portions of each dielectric layer 11, i.e., the center portion, the upper end portion, and the lower end portion in the Z-axis direction, i.e., the lamination direction of the dielectric layers 11. Alternatively, the imaging by the laser microscope or the like may be performed at positions corresponding to ¼, ½, and ¾ of the width of each dielectric layer 11.

### <Secondary Phase>

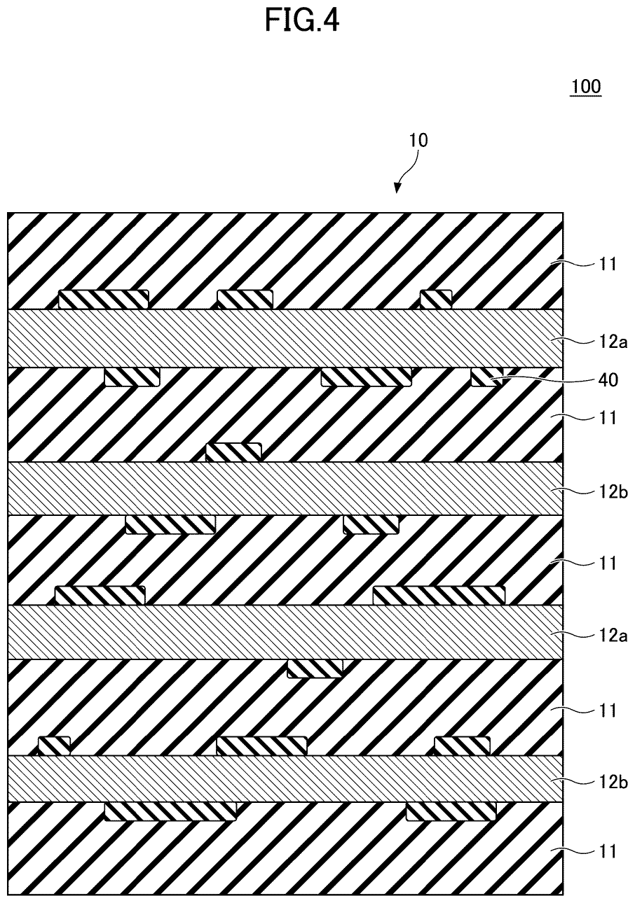

The dielectric layer 11 includes the secondary phase 40 covering the interface between the dielectric layer 11 and the internal electrode layer 12. Here, the secondary phase 40 will be specifically described with reference to FIG. 4. FIG. 4 is an enlarged diagram of a region C of FIG. 2.

In the present specification, the state in which the secondary phase covers the interface between the dielectric layer and the internal electrode layer means a state in which the secondary phase 40 is disposed between the dielectric layer 11 and the internal electrode layer 12 to contact both the dielectric layer 11 and the internal electrode layer 12.

The secondary phase 40 may be formed in a firing step described below. Specifically, the secondary phase 40 may be formed by firing an unfired material for internal electrode layer formation to be the internal electrode layer 12, and a secondary-phase component included in the unfired material. More specifically, the secondary phase 40 may be formed by firing these materials to segregate elements derived from the secondary-phase component discharged from the internal electrode layer 12.

No particular limitation is imposed on the secondary-phase component, and the secondary-phase component may be appropriately selected in accordance with the intended purpose. The secondary-phase component preferably includes at least one of Si, Al, B, Li, or Ca. This is because, preferably, the secondary-phase component forms into a liquid phase in the firing step, and does not readily remain in the internal electrode layer 12, i.e., the secondary-phase component is readily discharged from the internal electrode layer 12.

No particular limitation is imposed on the position of the secondary phase 40 formed in the dielectric layer 11 as long as the secondary phase 40 is disposed to cover a portion of the interface between the dielectric layer 11 and the internal electrode layer 12 (the first internal electrode layer 12a or the second internal electrode layer 12b). The secondary phase 40 may be disposed at the interface on the first internal electrode layer 12a side of the dielectric layer 11, at the interface on the second internal electrode layer 12b side of the dielectric layer 11, or at both of these interfaces.

The coverage of the interface by the secondary phase 40 is 30% or more. From the viewpoint of suppressing reduction in electrostatic capacitance of the multilayer ceramic capacitor, the coverage of the interface by the secondary phase 40 is preferably 35% or more and 50% or less, and more preferably 40% or more and 50% or less.

Of the secondary phase 40, the percentage of the secondary phase including Ni (hereinafter may be referred to as Ni-including secondary phase) is 80% or more, preferably 85% or more and 100% or less, and more preferably 90% or more and 100% or less.

When the coverage of the interface by the secondary phase 40 is 30% or more and the percentage of the secondary phase including Ni is 80% or more, diffusion of Ni from the unfired material for internal electrode layer formation is suppressed in the firing step. Thus, the internal electrode layer 12 obtained after firing is not readily discontinued, and the continuation percentage of the internal electrode layer 12 is increased. Also, since the secondary phase 40 formed by being discharged from the internal electrode layer 12 during the firing step includes Ni derived from the internal electrode layer 12, the secondary phase 40 has a high affinity with the internal electrode layer 12. Therefore, the secondary phase 40 can mechanically reinforce the internal electrode layer 12, thereby suppressing discontinuation of the internal electrode layer 12 and rounding of the internal electrode layer 12 during the firing step.

No particular limitation is imposed on the measurement method of the coverage of the interface by the secondary phase 40, and the measurement method may be appropriately selected in accordance with the intended purpose. For example, the coverage of the interface by the secondary phase 40 can be evaluated through observation of a cross section of the multilayer ceramic capacitor 100. More specifically, the measurement method is as follows. The multilayer ceramic capacitor is polished along the X-axis direction or the Y-axis direction to expose a YZ or XZ plane of the capacitor portion 14, and is subjected to thinning processing by FIB (Focused Ion Beam System) processing to prepare a thinned sample. Here, the plane to be exposed by polishing is preferably located near the center of the capacitor portion 14 in the X-axis direction or the Y-axis direction. The exposed plane is observed using an SEM (Scanning Electron Microscope) in about three fields of view each including a total of three or four layers of the dielectric layers 11 and the internal electrode layers 12, thereby obtaining an SEM image. Using image analysis software, such as IMAGE J or the like, the length of the interface between: each of the internal electrode layers included in the observed field of view; and the corresponding dielectric layer or secondary phase is measured from the obtained SEM image to obtain an internal electrode layer length. Also, the length of the interface between: each of the secondary phases included in the observed field of view and in contact with the corresponding internal electrode layer; and the corresponding internal electrode layer is measured to obtain a secondary phase length. Then, a value of {(secondary phase length/internal electrode layer length)×100}, calculated by dividing the secondary phase length by the internal electrode layer length, is defined as the coverage of the interface by the secondary phase in the observed field of view. The arithmetic mean value of the coverages of the interfaces by the secondary phases in all the fields of view observed by the same procedure is defined as the coverage of the interface by the secondary phase of the evaluated multilayer ceramic capacitor.

No particular limitation is imposed on the measurement method of the percentage of the Ni-including secondary phase, and the measurement method may be appropriately selected in accordance with the intended purpose. For example, the measurement method is as follows. Specifically, a thinned sample is prepared in the same manner as in the measurement method of the coverage of the interface by the secondary phase 40. Element mapping is performed on an exposed plane of the thinned sample through SEM-EDS (Scanning Electron Microscope-Energy Dispersive X-ray Spectroscopy) to determine a distribution range of Ni. Next, an SEM image is obtained in the same manner as in the measurement method of the coverage of the interface by the secondary phase 40. Using image analysis software, such as IMAGE J or the like, Ni-distributed regions of the secondary phases 40 included in the observed field of view and in contact with the internal electrode layer 12 are measured from the obtained SEM image, for the length of the interface with the internal electrode layer 12, thereby obtaining an Ni-including secondary phase length. Then, a value of {(Ni-including secondary phase length/internal electrode layer length)×100}, calculated by dividing the Ni-including secondary phase length by the internal electrode layer length, is defined as the coverage of the interface by the Ni-including secondary phase in the observed field of view. The arithmetic mean value of the coverages of the interfaces by the Ni-including secondary phases in all the fields of view observed by the same procedure is defined as the coverage of the interface by the Ni-including secondary phase of the evaluated multilayer ceramic capacitor. A value of {(coverage of the interface by the Ni-including secondary phase/coverage of the interface by the secondary phase)×100}, calculated by dividing the coverage of the interface by the Ni-including secondary phase by the coverage of the interface by the secondary phase, is defined as the percentage of the Ni-including secondary phase.

The coverage of the interface by the secondary phase 40, and the percentage of the Ni-including secondary phase can be controlled, for example, by adjusting the amount of the secondary-phase component in a powder for internal electrode layer formation.

From the viewpoint of controlling the coverage of the interface by the secondary phase 40 and the percentage of the Ni-including secondary phase to be in the above respective ranges, the amount of the secondary-phase component in the powder for internal electrode layer formation is preferably 5% by volume or more and 25% by volume or less relative to the total amount of the powder for internal electrode layer formation.

### (Internal Electrode Layer)

The internal electrode layer 12 is free from a co-existent material. The co-existent material is a dielectric particle having a composition that is the same as that of the ceramic particle (perovskite compound) described above, which is used for the formation of internal electrode layers of a typical multilayer ceramic capacitor. Since the internal electrode layer 12 is free from a co-existent material, i.e., no co-existent material remains in the internal electrode layer after firing, the internal electrode layer is not readily discontinued, and the continuation percentage of the internal electrode layer can be increased.

In the present specification, the description of the internal electrode layer being free from a co-existent material means that the amount of the co-existent material in the internal electrode layer 12 is 5% by mole or less relative to the main component metal element of the internal electrode layer 12.

The internal electrode layer 12 being free from a co-existent material can be evaluated, for example, through observation of a cross section of the multilayer ceramic capacitor 100. More specifically, the evaluation method is as follows.

A thinned sample is prepared in the same manner as in the measurement method of the coverage of the interface by the secondary phase 40. Element mapping by SEM-EDS is performed on an exposed plane of the thinned sample including the internal electrode layer. From the results of the element mapping, the amount by mole of the co-existent material component included in the internal electrode layer is calculated. Similarly, from the results of the element mapping, the amount by mole of the main component metal element included in the internal electrode layer is calculated. Then, the internal electrode layer 12 being free from a co-existent material can be confirmed by determining a ratio of the amount by mole of the co-existent material component to the amount by mole of the main component metal element. The amount of the co-existent material in the internal electrode layer is preferably an arithmetic mean value of the amounts of the co-existent material obtained from element mapping information, which is obtained through analysis of about three points respectively at the center portion and both end portions of the internal electrode layer.

The internal electrode layer 12 includes Ni as a main component. Since the internal electrode layer 12 includes Ni as a main component, it is possible to achieve excellent electrical characteristics and cost reduction.

In addition to Ni, the internal electrode layer 12 may include a base metal, such as tin (Sn) or the like, a noble metal, such as platinum (Pt), palladium (Pd), silver (Ag), gold (Au), or the like, or an alloy including these.

The main component included in the first internal electrode layers 12a and the main component included in the second internal electrode layers 12b may be the same as or different from each other.

In addition to the main component metal, the internal electrode layer 12 may include an additive metal element. When the internal electrode layer 12 includes an additive metal element, the additive metal element is, for example, a metal that is nobler than the main component metal of the internal electrode layer 12. A specific example of the additive metal element is, for example, one or more elements selected from the group consisting of Cr (chromium), Y (yttrium), In (indium), As (arsenic), Co (cobalt), Cu (copper), Ir (iridium), Mg (magnesium), Os (osmium), Re (rhenium), Rh (rhodium), Ru (ruthenium), Se (selenium), Te (tellurium), W (tungsten), and Zn (zinc). For example, the internal electrode layer 12 may include copper (Cu). Cu may form an alloy with Ni. When the internal electrode layer 12 includes copper, interfacial resistance between the internal electrode layer 12 and the dielectric layer 11 increases to exhibit the effect of extending the lifetime of a resulting MLCC.

No particular limitation is imposed on the concentration (atomic %) of copper in the internal electrode layers 12. The concentration (atomic %) of copper in the internal electrode layers 12 may be appropriately selected in accordance with the intended purpose, and is preferably 2.5 atomic % or less, more preferably 2 atomic % or less, further preferably 1.5 atomic % or less, and particularly preferably 1 atomic % or less. When the concentration (atomic %) of copper in the internal electrode layers 12 is set in the above range, it is possible to prevent reduction in continuation of the internal electrode layers 12 due to the melting point of the internal electrode layers 12 being lowered by an excess amount of copper included in the internal electrode layers 12. Also, from the viewpoint of improving the lifetime characteristics, the concentration (atomic %) of copper in the internal electrode layers 12 is preferably 0.2 atomic % or more, more preferably 0.3 atomic % or more, and further preferably 0.5 atomic % or more.

No particular limitation is imposed on the measurement method of the concentration of copper in the internal electrode layers 12, and the measurement method may be appropriately selected in accordance with the intended purpose. For example, the concentration of copper in the internal electrode layers 12 may be an average of the concentrations (atomic %) of copper in regions of the internal electrode layers 12, in a graph of a concentration distribution obtained through TEM-EDX analysis. When a strict boundary is required, the region of the internal electrode layers 12 may be a region in which the oxygen concentration is less than 5 atomic %. Here, the concentration of copper is a percentage of copper atoms relative to all the elements included in the internal electrode layers 12.

The average thickness of the internal electrode layers 12 is less than 500 nanometers (nm), preferably 100 nm or greater and 400 nm or less, and more preferably 100 nm or greater and 300 nm or less.

When the average thickness of the internal electrode layers 12 is 100 nm or greater, internal electrodes are not readily lost during firing, and can ensure function as the internal electrodes. When the average thickness of the internal electrode layers 12 is 300 nm or less, the electrostatic capacitance can be increased by increasing the number of laminated layers of the capacitor portion 14 even if the size of the multilayer ceramic capacitor is the same. In other words, the average thickness of the internal electrode layers 12 is preferably 300 nm or less from the viewpoint of obtaining a smaller multilayer ceramic capacitor having the same performance. From the viewpoint of increasing the electrostatic capacitance by increasing the number of laminated layers, the average thickness of the internal electrode layers 12 is preferably 250 nm or less and more preferably 200 nm or less.

No particular limitation is imposed on the measurement method of the thickness of the internal electrode layers 12, and the measurement method may be appropriately selected in accordance with the intended purpose. The thickness of the internal electrode layers 12 can be measured, for example, by a method similar to the measurement method of the thickness of the dielectric layers 11.

The continuation percentage of the internal electrode layer 12 is preferably 85% or more, and more preferably 90% or more.

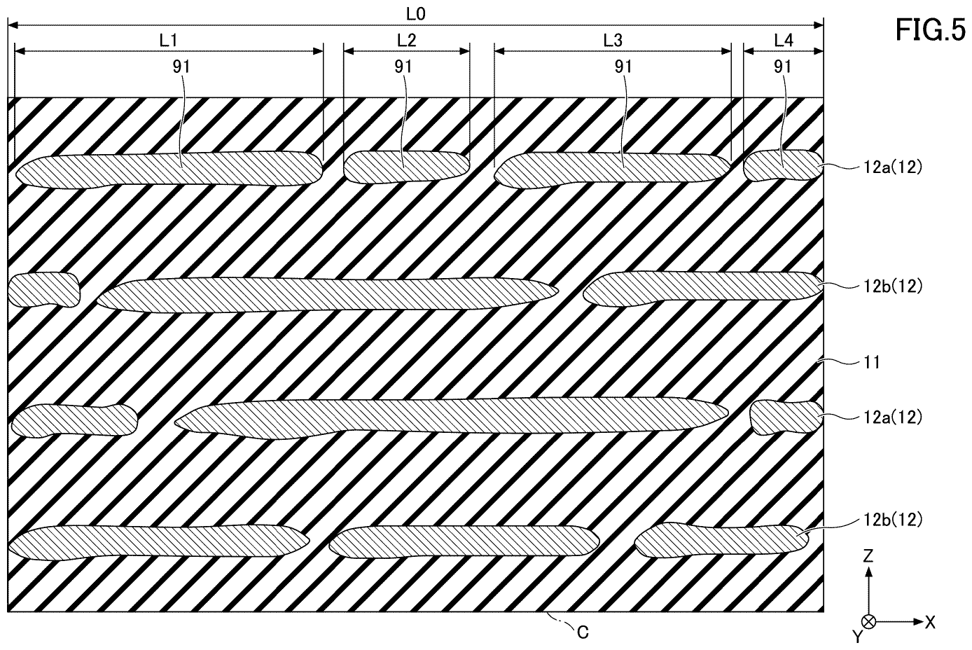

No particular limitation is imposed on the measurement method of the continuation percentage of the internal electrode layer 12, and the measurement method may be appropriately selected in accordance with the intended purpose. For example, the measurement method is as follows. Specifically, by a method that is the same as the measurement method of the thickness of the dielectric layer 11, an XZ or YZ plane exposed by polishing is imaged by a laser microscope or the like, and about 5 to about 10 layers are selected from each of the center portion, the upper end portion, and the lower end portion in the Z-axis direction, i.e., the lamination direction of the internal electrode layers 12, such that a total of 15 to 20 internal electrode layers 12 are selected. FIG. 5 is a schematic diagram of the obtained image. In the obtained image, electrode portions 91, 91, . . . , each of which is a continuous portion of the internal electrode layer 12 without any gap, are determined by contrast or the like, and the lengths of the electrode portions 91, 91, . . . at the center in the Z-axis direction are measured. Then, for example, for one of the internal electrode layers 12, lengths L1, L2, . . . , and Ln of the electrode portions 91, 91, . . . are measured, and a value of {(L1+L2+ . . . +Ln)/L0}, calculated by dividing the sum of the lengths L1, L2, . . . by a length L0 in a measurement region, can be used as the continuation percentage (%) of the one internal electrode layer 12. Further, the continuation percentage is calculated in the same manner for each of the other internal electrode layers 12 in the obtained image, and the average of the calculated continuation percentages can be used as the continuation percentage (%) of the internal electrode layers 12 in the multilayer ceramic capacitor. The total number of the internal electrode layers 12 for the measurement of the continuation percentage preferably includes the first internal electrode layers 12a and the second internal electrode layers 12b in the same numbers. For the measurement of the continuation percentage, an image obtained by a scanning electron microscope (SEM) can also be used.

### [Production Method of Multilayer Ceramic Capacitor]

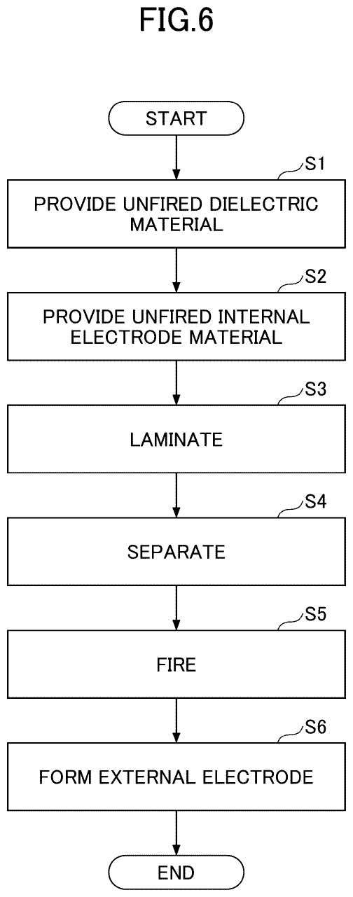

Next, a production method of the multilayer ceramic capacitor 100 as described above will be described. FIG. 6 is a flowchart illustrating the production method of the multilayer ceramic capacitor 100 according to the embodiment.

The present embodiment may be a production method of the multilayer ceramic capacitor including the body including the dielectric layers and the internal electrode layers that are alternately laminated in the first-axis direction, in which the internal electrode layers include Ni, the dielectric layers include the perovskite compound represented by the general formula ABO₃, the internal electrode layers are free from the co-existent material, and the average thickness of the internal electrode layers is less than 500 nm. The production method of the multilayer ceramic capacitor includes: a lamination step of alternately laminating unfired dielectric materials to be the dielectric layers and unfired internal electrode materials to be the internal electrode layers, thereby obtaining a laminate; and a firing step of firing the laminate, in which the dielectric layers include secondary phases covering interfaces between the dielectric layers and the internal electrode layers, the coverage of the interfaces by the secondary phases is 30% or more, and of the secondary phases, the percentage of the secondary phases including Ni is 80% or more.

(Unfired Dielectric Material Providing Step (S1)) In the unfired dielectric material providing step (S1), a ceramic green sheet (unfired dielectric material) to be the dielectric layers 11 through firing is provided.

First, a powder for dielectric layer formation is provided. The powder for dielectric layer formation includes a ceramic powder.

The ceramic powder may be a powder of the ceramic material described above for the dielectric layers 11 of the multilayer ceramic capacitor 100. That is, the ceramic powder includes a powder of the perovskite compound represented by the general formula ABO₃, and preferably includes barium titanate.

A predetermined additive may be added to the powder for dielectric layer formation in accordance with the intended purpose. The powder for dielectric layer formation is mixed through a wet process with or without addition of an additive. The resulting mixture is dried and then pulverized, followed by wet mixing with a binder, such as a polyvinyl butyral (PVB) resin or the like, an organic solvent, such as ethanol, toluene, or the like, and a plasticizer, thereby preparing a slurry for dielectric layer formation. The obtained slurry for dielectric layer formation is coated on a base, such as a polyethylene terephthalate (PET) film or the like, by a method, such as a die coater method, a doctor blade method, or the like, followed by drying to obtain the ceramic green sheet (unfired dielectric material).

### (Unfired Internal Electrode Material Providing Step (S2))

In the unfired internal electrode material providing step (S2), an unfired internal electrode material to be the internal electrode layers 12, i.e., the first internal electrode layers 12a and the second internal electrode layers 12b, is provided. A metal serving as a main component of the unfired internal electrode material is Ni from the viewpoint of achieving excellent electrical characteristics and cost reduction. Also, a metal material that may be included is a metal material similar to the material described above for the internal electrode layers 12 of the multilayer ceramic capacitor 100 (e.g., a base metal, such as Sn or the like, a noble metal, such as Pt, Pd, Ag, Au, or the like, or an alloy including these).

The metal material may include an additive metal element in addition to the main component metal. When the metal material includes an additive metal element, the additive metal element is, for example, a metal that is nobler than the main component metal of the internal electrode layers 12. A specific example of the additive metal element is, for example, one or more elements selected from the group consisting of Cr (chromium), Y (yttrium), In (indium), As (arsenic), Co (cobalt), Cu (copper), Ir (iridium), Mg (magnesium), Os (osmium), Re (rhenium), Rh (rhodium), Ru (ruthenium), Se (selenium), Te (tellurium), W (tungsten), and Zn (zinc). For example, when the main component metal of the internal electrode layers 12 is Ni, Cu may be added. Then, the metal material after the addition of Cu, a secondary-phase component, an organic binder, and a solvent are kneaded to obtain a metal paste (unfired internal electrode material). Note that no co-existent material is added to the metal paste. Cu may be added after the preparation of the metal paste from the main component metal material. Cu is preferably added as an oxide. Examples of the oxide of Cu include copper oxide and the like.

The metal paste (unfired internal electrode material) includes the secondary-phase component. No particular limitation is imposed on the form of the secondary-phase component added to the metal paste, and the form may be appropriately selected in accordance with the intended purpose. For example, the secondary-phase component can be added as a powder of an oxide, a carbonate, or the like. The amount of the secondary-phase component added can be adjusted such that the coverage of the interface by the secondary phase is 30% or more and such that, of the secondary phases, the percentage of the secondary phases including Ni is 80% or more. By adjusting the amount of the secondary-phase component in the above-described manner, the internal electrode layers in the multilayer ceramic capacitor are not readily discontinued, i.e., the continuation percentage of the internal electrode layers is increased.

### (Lamination Step (S3))

In the lamination step (S3), using a method, such as screen printing, gravure printing, or the like, the metal paste obtained in the unfired internal electrode material providing step (S2) is printed on the surface of the ceramic green sheet obtained in the unfired dielectric material providing step (S1). This can dispose, on the surface of the ceramic green sheet, a first internal electrode pattern to be the first internal electrode layers 12a and a second internal electrode pattern to be the second internal electrode layers 12b. A formation method of the internal electrode patterns is not limited to printing, and can be another method using a mask, such as plating, vacuum vapor deposition, sputtering, chemical vapor deposition (CVD), or the like.

The ceramic green sheet on which the metal paste is coated is laminated such that the internal electrode layers 12 are alternately routed out to a pair of the external electrodes 20a and 20b, which are disposed in the longitudinal direction (X-axis direction) of the dielectric layers 11. For this lamination, a publicly known technique can be used. For example, for forming the side margin 16 to be an outer region in the Y-axis direction in a portion of the capacitor portion 14 to which the internal electrode layers 12 are not routed out, an unfired dielectric material can be disposed in a peripheral region in which the internal electrode pattern of the metal paste is not printed. When the ceramic green sheet on which the metal paste is printed is regarded as a laminated unit, the number of layers of the laminated unit can be 100 or more and 500 or less.

Subsequently, a laminate is obtained by respectively laminating cover sheets, which are unfired cover materials for the formation of cover layers, on the top and bottom of the laminate in which the ceramic green sheet and the internal electrode pattern were obtained, i.e., on both sides in the lamination direction (Z-axis direction). The cover sheets may be formed, mainly using a ceramic powder, by the same method as that used for forming the unfired dielectric material for the formation of the dielectric layers. Also, the cover sheets may be formed from the same material as that of the unfired dielectric material for the formation of the dielectric layers. The number of laminated cover sheets may be 2 or more and 10 or less per one side.

The obtained laminate is pressure-bonded in the lamination direction (Z-axis direction) to obtain a pressure-bonded body.

### (Separation Step (S4))

The pressure-bonded body can be separated by being cut to a predetermined size through dicing with a dicer, laser cutting, or the like. An existing technique can be appropriately used as a separation method of the pressure-bonded body.

### (Firing Step (S5))

In the firing step (S5), the separated laminates are fired. No particular limitation is imposed on firing conditions, and the firing conditions may be appropriately selected in accordance with the intended purpose. The hydrogen concentration is preferably 0.03% by volume or more and 1.0% by volume or less, and more preferably 0.05% by volume or more and 0.3% by volume or less. The composition of a reducing atmosphere other than hydrogen is nitrogen or argon. In the firing step (S5), the secondary-phase component previously added to an unsintered internal electrode material segregates to the interface, thereby forming the secondary phases 40.

The firing temperature in the firing step (S5) is preferably 1,000° C. or higher and 1,350° C. or lower, and more preferably 1,150° C. or higher and 1,300° C. or lower. The firing time in the firing step (S5) may be 30 minutes or greater and 2 hours or less.

### (External Electrode Forming Step (S6))

In the external electrode forming step, the first external electrode 20a and the second external electrode 20b can be formed through plating or the like. Thus, the multilayer ceramic capacitor 100 described above is completed.

### EXAMPLES

Hereinafter, the present disclosure will be described in more detail by way of Examples and Comparative Examples.

### Example 1

### <Production of Multilayer Ceramic Capacitor>

A polyvinyl butyral (PVB) resin, a solvent, a plasticizer, a sintering aid powder, which is an Si compound, and an additive, such as a rare earth element or the like, were added to a barium titanate powder for dielectric layer formation, followed by mixing through a wet process to prepare a ceramic slurry. The ceramic slurry was coated on a base film using a doctor blade to form a dielectric green sheet having a thickness after sintering of 0.5 micrometers.

A secondary-phase component (SiO₂), a polyvinyl butyral (PVB) resin, a solvent, and a plasticizer were kneaded with a nickel powder to obtain a metal paste for internal electrode layer formation. The amounts of these materials were adjusted such that the amount of the secondary-phase component would be 15% by volume. The metal paste was printed on the dielectric green sheet to form an internal electrode layer pattern.

Five-hundred dielectric green sheets on which the metal paste was printed were laminated. Further, dielectric green sheets serving as the cover layers were disposed on both sides in the lamination direction to form a laminate.

The obtained laminate was pressure-bonded, and then cut to a predetermined size to obtain separated shaped chips. The obtained shaped chips were subjected to a binder removing treatment in an N₂ atmosphere, and a metal paste to be a base layer of the external electrode was coated thereon by a dip method. Subsequently, the shaped chips were placed in a firing furnace, and fired for 10 minutes in the firing furnace in which the temperature of the firing furnace (firing temperature) was increased to 1,200° C. in an atmosphere having an H₂ concentration of 0.1% by volume and an N₂ concentration of 99.9% by volume. The external electrodes were formed on the fired shaped chips through plating, thereby producing a multilayer ceramic capacitor (MLCC) having a dimension of 1.0 mm×0.5 mm×0.5 mm.

### [Measurement of Thickness of Internal Electrode Layer]

The multilayer ceramic capacitor was polished along the X-axis direction to expose the YZ plane of the capacitor portion 14. Here, the plane exposed through polishing was a plane near the center of the capacitor portion 14 in the X-axis direction. The exposed surface was imaged by a laser microscope or the like, and about 5 to about 10 layers were selected from each of the center portion, the upper end portion, and the lower end portion in the Z-axis direction, i.e., the lamination direction of the internal electrode layers 12, such that a total of 15 to 20 internal electrode layers 12 were selected. The thickness (length in the Z-axis direction) of each of the selected internal electrode layers 12 was measured at positions corresponding to ¼, ½, and ¾ of the width of each internal electrode layer 12, and the average of the measurement values was defined as the thickness (micrometer) of each internal electrode layer 12. The thicknesses of all the selected internal electrode layers 12 each measured in this manner were averaged, and the obtained average of the thicknesses of all the selected internal electrode layers 12 was used as the thickness (average thickness) (micrometer) of the internal electrode layers 12. The results are shown in Table 1.

### [Measurement of Coverage of Interface by Secondary Phase]

The multilayer ceramic capacitor was polished along the X-axis direction or the Y-axis direction to expose a YZ or XZ plane of the capacitor portion 14, and was subjected to thinning processing by FIB processing to prepare a thinned sample. Here, the plane exposed by polishing was located near the center of the capacitor portion 14 in the X-axis direction or the Y-axis direction. The exposed plane was observed using an SEM in about three fields of view each including a total of three or four layers of the dielectric layers 11 and the internal electrode layers 12, thereby obtaining an SEM image. Using image analysis software IMAGE J, the length of the interface between: each of the internal electrode layers included in the observed field of view; and the corresponding dielectric layer or secondary phase was measured from the obtained SEM image to obtain an internal electrode layer length. Also, the length of the interface between: each of the secondary phases included in the observed field of view and in contact with the corresponding internal electrode layer; and the corresponding internal electrode layer was measured to obtain a secondary phase length. Then, a value of {(secondary phase length/internal electrode layer length)×100}, calculated by dividing the secondary phase length by the internal electrode layer length, was defined as the coverage of the interface by the secondary phase in the observed field of view. The arithmetic mean value of the coverages of the interfaces by the secondary phases in all the fields of view observed by the same procedure was defined as the coverage of the interface by the secondary phase of the evaluated multilayer ceramic capacitor. The results are shown in Table 1.

### [Measurement of Percentage of Ni-Including Secondary Phase]

A thinned sample was prepared in the same manner as in the [Measurement of Coverage of Interface by Secondary Phase]. Element mapping by SEM-EDS was performed on an exposed plane of the thinned sample to determine a distribution range of Ni. Next, an SEM image was obtained in the same manner as in the [Measurement of Coverage of Interface by Secondary Phase]. Using image analysis software IMAGE J, from the obtained SEM image, Ni-distributed regions of the secondary phases 40 included in the observed field of view and in contact with the internal electrode layer 12 were measured for the length of the interface with the internal electrode layer 12, thereby obtaining an Ni-including secondary phase length. Then, a value of {(Ni-including secondary phase length/internal electrode layer length)×100}, calculated by dividing the Ni-including secondary phase length by the internal electrode layer length, was defined as the coverage of the interface by the Ni-including secondary phase in the observed field of view. The arithmetic mean value of the coverages of the interfaces by the Ni-including secondary phases in all the fields of view observed by the same procedure was defined as the coverage of the interface by the Ni-including secondary phase of the evaluated multilayer ceramic capacitor. A value of {(coverage of the interface by the Ni-including secondary phase/coverage of the interface by the secondary phase)×100}, calculated by dividing the coverage of the interface by the Ni-including secondary phase by the coverage of the interface by the secondary phase, was defined as the percentage of the Ni-including secondary phase. The results are shown in Table 1.

### [Confirmation of Presence or Absence of Co-Existent Material in Internal Electrode Layer]

A thinned sample was prepared in the same manner as in the [Measurement of Thickness of Internal Electrode Layer]. Element mapping by SEM-EDS was performed on an exposed plane of the thinned sample including the internal electrode layer. From the results of the element mapping, the amount by mole of the co-existent material component included in the internal electrode layer was calculated. Similarly, from the results of the element mapping, the amount by mole of the main component metal element included in the internal electrode layer was calculated. Then, the presence or absence of the co-existent material was confirmed by determining a ratio of the amount by mole of the co-existent material component to the amount by mole of the main component metal element. The amount of the co-existent material in the internal electrode layer was an arithmetic mean value of the amounts of the co-existent material obtained from element mapping information, which was obtained through analysis of three points respectively at the center portion and both end portions of the internal electrode layer. The amount of the co-existent material in the internal electrode layer being less than 5% by mole relative to the main metal element of the internal electrode layer was regarded as indicating that the co-existent material was not included in the internal electrode layer, and this case was indicated as Absent. The amount of the co-existent material in the internal electrode layer being 5% by mole or more relative to the main metal element of the internal electrode layer was regarded as indicating that the co-existent material was included in the internal electrode layer, and this case was indicated as Present. The results are shown in Table 1.

### [Measurement of Continuation Percentage of Internal Electrode Layer]

The formed multilayer ceramic capacitor was polished along the X-axis direction to expose a YZ plane of the multilayer ceramic capacitor. The exposed plane was used as an observation plane, and imaged by a laser microscope. For each of the first internal electrode layer 12a and the second internal electrode layer 12b, five layers were selected from each of the center portion, the upper end portion, and the lower end portion in the Z-axis direction, i.e., the lamination direction of the internal electrode layers, such that a total of fifteen internal electrode layers 12 were selected for each of the first internal electrode layer 12a and the second internal electrode layer 12b. In the obtained image illustrated in FIG. 5, the length of each of the portions 91, 91, . . . , each of which is a portion continuous along the X-axis direction without any gap, was measured. For each of the internal electrode layers 12 (the fifteen first internal electrode layers 12a and the fifteen second internal electrode layers 12b), a value of (L1+L2+ . . . +Ln)/L0), calculated by dividing the sum of the lengths L1, L2, . . . , and Ln of the electrode portions 91, 91, . . . by the length of the measurement region L0, was defined as the continuation percentage (%) of each of the first internal electrode layer 12a and the second internal electrode layer 12b. Further, the average of the measured continuation percentages was determined to be the continuation percentage (%) of the internal electrode layers 12. The multilayer ceramic capacitor in which the continuation percentage of the internal electrode layers 12 was 85% or more was determined as pass. Especially, the multilayer ceramic capacitor in which the continuation percentage more than 90% was determined as A, the multilayer ceramic capacitor in which the continuation percentage was more than 85% and 90% or less was determined as B, the multilayer ceramic capacitor in which the continuation percentage was 80% or more and less than 85% was determined as C, and the other multilayer ceramic capacitors were determined as D. In Table 1, A is better than B, B is better than C, and C is better than D.

### Examples 2 to 5 and Comparative Examples 1 to 6

As shown in Table 1, the multilayer ceramic capacitors were prepared, and evaluated, in the same manner as in Example 1, except that the composition of the powder for dielectric layer formation was changed. In Comparative Examples 1 to 3, barium titanate was added as a co-existent material to the metal paste for internal electrode layer formation. The results are shown in Table 1.

TABLE 1

| | | Presence or | | | | |
|---|---|---|---|---|---|---|
| | | absence of co- | | | | |
| | Average | existent | | | Continuation | |
| | thickness of | material in | Coverage of | Percentage of | percentage of | |
| | internal | internal | interface by | Ni-including | internal | |
| | electrode | electrode | secondary | secondary | electrode | |
| | layers | layer | phase | phase | layer | Evaluation |
| Example 1 | 290 nm | Absent | 32% | 82% | 89% | B |
| Example 2 | 295 nm | Absent | 35% | 90% | 90% | B |
| Example 3 | 300 nm | Absent | 42% | 85% | 91% | A |
| Example 4 | 250 nm | Absent | 34% | 86% | 86% | B |
| Example 5 | 490 nm | Absent | 45% | 91% | 95% | A |
| Comparative | 400 nm | Present | 19% | 0% | 80% | C |
| Example 1 | | | | | | |
| Comparative | 300 nm | Present | 16% | 0% | 64% | D |
| Example 2 | | | | | | |
| Comparative | 295 nm | Present | 32% | 84% | 80% | C |
| Example 3 | | | | | | |
| Comparative | 300 nm | Absent | 34% | 0% | 81% | C |
| Example 4 | | | | | | |
| Comparative | 290 nm | Absent | 33% | 71% | 85% | C |
| Example 5 | | | | | | |
| Comparative | 520 nm | Present | 17% | 0% | 88% | B |
| Example 6 | | | | | | |

As shown in Table 1, each of the multilayer ceramic capacitors of the present embodiment exhibited an excellent continuation percentage of the internal electrode layers. Especially the multilayer ceramic capacitors of Examples 3 and 5, in which the coverage of the interface by the secondary phase was more than 40%, exhibited especially excellent continuation percentages of the internal electrode layers, i.e., more than 90%.

Each of the multilayer ceramic capacitors of Comparative Examples 1 to 3, in which the co-existent material was included in the metal paste for internal electrode layer formation, exhibited a poor continuation percentage of the internal electrode layers. This is likely because the co-existent material was included in the metal paste for internal electrode layer formation, and thus the co-existent material remained in the internal electrode layers. Also, each of the multilayer ceramic capacitors of Comparative Examples 4 and 5, in which the percentage of the Ni-including secondary phase was less than 80%, exhibited a poor continuation percentage of the internal electrode layers regardless of the absence of the co-existent material in the metal paste for internal electrode layer formation. This is likely because the Ni-including secondary phase was less, and thus affinity between the internal electrode layer and the secondary phase decreased to weaken the mechanical reinforcing effect caused by the secondary phase.

The multilayer ceramic capacitor of Comparative Example 6 not having the configuration of the present disclosure, in which the co-existent material was included in the internal electrode layer, the coverage of the interface by the secondary phase was less than 30%, and the percentage of the Ni-including secondary phase was less than 80%, exhibited a continuation percentage of the internal electrode layer of 90%. This is likely because, in the multilayer ceramic capacitor of Comparative Example 6, the average thickness of the internal electrode layers was sufficiently large, and thus the internal electrode layer was not readily discontinued to maintain the continuation percentage of the internal electrode layers. When comparing Comparative Example 6 with Comparative Examples 1 and 2, which are different from Comparative Example 6 only in the average thickness of the internal electrode layers, it is clearly found that the continuation percentage of the internal electrode layers decreases to 88%, 80%, and 64% as the average thickness of the internal electrode layers decreases to 520 nm, 400 nm, and 300 nm. In Examples 1 to 6, the continuation percentage is excellent even in a range in which the average thickness of the internal electrode layers is less than 500 nm. Although the average thickness of the internal electrode layers in Example 5 is substantially equal to that in Comparative Example 6, the continuation percentage of the internal electrode layers is further increased by the effect of the present disclosure.

Although the embodiments of the present disclosure have been described above in detail, the present disclosure is not limited to the above-described embodiments. Various changes, modification, substitutions, additions, deletions, combinations, and the like are possible in the above-described embodiments within the scope of claims recited.

The embodiments of the present disclosure are, for example, as follows.
<1> A multilayer ceramic capacitor, including:
a body including a plurality of dielectric layers and a plurality of internal electrode layers that are alternately laminated in a first-axis direction, wherein the internal electrode layers include Ni,
the dielectric layers include a perovskite compound represented by general formula ABO₃,
the internal electrode layers are free from a co-existent material,
an average thickness of the internal electrode layers is less than 500 nm,
the dielectric layers include secondary phases covering interfaces between the dielectric layers and the internal electrode layers,
a coverage of the interfaces by the secondary phases is 30% or more, and
of the secondary phases, a percentage of the secondary phases including Ni is 80% or more.
<2> The multilayer ceramic capacitor according to <1>, wherein
the average thickness of the internal electrode layers is 300 nm or less.
<3> The multilayer ceramic capacitor according to <1> or <2>, wherein
the secondary phases include at least one of Si, Al, B, Li, or Ca.
<4> The multilayer ceramic capacitor according to <1> or <2>, wherein
the perovskite compound includes barium titanate.

What is claimed is:

1. A multilayer ceramic capacitor, comprising:
a body including a plurality of dielectric layers and a plurality of internal electrode layers that are alternately laminated in a first-axis direction, wherein
the internal electrode layers include Ni,
the dielectric layers include a perovskite compound represented by general formula ABO₃,
the internal electrode layers are free from a co-existent material,
an average thickness of the internal electrode layers is less than 500 nm,
the dielectric layers include secondary phases covering interfaces between the dielectric layers and the internal electrode layers,
a coverage of the interfaces by the secondary phases is 30% or more, and
of the secondary phases, a percentage of the secondary phases including Ni is 80% or more.

2. The multilayer ceramic capacitor according to claim 1, wherein
the average thickness of the internal electrode layers is 300 nm or less.

3. The multilayer ceramic capacitor according to claim 1, wherein
the secondary phases include at least one of Si, Al, B, Li, or Ca.

4. The multilayer ceramic capacitor according to claim 1, wherein
the perovskite compound includes barium titanate.
